(19) United States
(12) Patent Application Publication
(10) Pub. No.: US 2018/0119902 A1
(43) Pub. Date: May 3, 2018

(54) LIGHTING DEVICES INCLUDING FORMED FLEXIBLE LIGHT ENGINES

(71) Applicants: OSRAM SYLVANIA Inc., Wilmington, MA (US); OSRAM GmbH, Munich (DE); OSRAM S.P.A. - SOCIETA' RIUNITE OSRAM EDISON CLERICI, Milano (IT)

(72) Inventors: Qi Dai, Shanghai (CN); Bruce Radl, Stow, MA (US); Richard Speer, Concord, MA (US); Qiong Huang, Winchester, MA (US); Rodrigo Pereyra, Salem, MA (US); Maxim Tchoul, Winchester, MA (US); Alessandro Scordino, Dolo (IT); Lorenzo Baldo, Giavera del Montello (IT); Simon Bobbo, Treviso (IT); Dina Pasqualini, Udine (IT); Geert van der Meer, Ismaning (NL); Sridharan Venk, Treviso (IT)

(73) Assignees: OSRAM SYLVANIA Inc., Wilmington, MA (US); OSRAM GmbH, Munich (DE); OSRAM S.P.A. - SOCIETA' RIUNITE OSRAM EDISON CLERICI, Milano (IT)

(21) Appl. No.: 15/513,974

(22) PCT Filed: Sep. 23, 2015
(86) PCT No.: PCT/US2015/051697

§ 371 Date: Mar. 23, 2017

Related U.S. Application Data
(60) Provisional application No. 62/054,218, filed on Sep. 23, 2014.

(51) Int. Cl. F21S 4/22; F21V 23/00; F21V 3/02; F21V 17/10; F21V 7/22

(52) U.S. Cl. CPC F21S 4/22; F21V 23/005; F21Y 2103/10; F21V 17/101; F21V 7/22; F21V 3/02

(57) ABSTRACT

Lighting devices, and methods of manufacturing the same, are provided. A lighting device includes a cover through which emitted light passes and a formed flexible light engine. The formed flexible light engine is placed within a housing, or serves as the housing itself. An interface couples to cover to the housing or the formed flexible light engine. The formed flexible light engine includes a flexible substrate and a plurality of solid state light sources located thereon. The plurality of solid state light sources are configured to emit light through the cover. The formed light engine has a defined shape created during the forming process. This enables placement on the housing within the lighting device, or contributes to the overall shape of the lighting device.

### CROSS-REFERENCE TO RELATED APPLICATION

The present application is an international application of, and claims priority to, U.S. Provisional Patent Application No. 62/054,218, entitled “THERMOFORMED FLEXIBLE LIGHT ENGINE AND LIGHTING DEVICES INCLUDING SAME” and filed on Sep. 23, 2014, the entire contents of which are hereby incorporated by reference.

### TECHNICAL FIELD

The present invention relates to lighting, and more specifically, to lighting devices including one or more flexible substrates.

### BACKGROUND

Conventional light engines including solid state light sources are typically made on a rigid, or substantially rigid, substrate, such as but not limited to FR4, metal core PCB, etc. Thus, a conventional light engine is flat, or substantially flat, as these materials have a little ability to bend slightly when held in such a shape.

### SUMMARY

Conventional flat light engines, such as described above, introduce a geometry limitation to any lighting device (lamp, module, luminaire, fixture, etc.) in which the conventional light engine is placed as a light source. That is, the lighting device must be able to accommodate the (substantially) flat and (substantially) rigid light engine. This geometry limitation may also reduce the optical and/or thermal efficiencies of the lighting device, among other issues. Alternatively, the lighting device may need to be designed in such a way as to compensate for the reduced optical and/or thermal efficiency from use of the (substantially) flat and (substantially) rigid light engine, which introduces additional complexity and cost. Further, certain types of lighting devices have shapes (e.g., curves, semi-circles, spheres, etc.) that are not conducive to receiving a (substantially) flat, (substantially) rigid light engine. Additional materials and costs are then introduced to attach two objects together that do not otherwise fit well.

For example, consider a lighting device including a conventional light engine where the lighting device has a substantially rectangular cross-section. Typically, the conventional light engine is attached to a heat sink, or to a housing (or both), and the combination is then attached to a cover. Within the device, the light engine is generally as far from the cover as possible. However, there must be some interface between the cover and the combination, so as to keep the pieces together. This interface, which is typically above the light engine, thus blocks some of the light emitted by the light engine, resulting in both decreased light output and decreased optical efficiency. If the location of the light engine within the lighting device is changed, so that the light engine is above the interface, the interface no longer blocks some of the light emitted by the light engine. However, the location of the light engine within the lighting device, being closer to the cover, results in a pixilation effect. Now, anyone looking at the lighting device is able to see the individual solid state light sources of the light engine. The pixilation effect is highly undesirable, particularly in lighting devices including solid state light sources that are meant to replace traditional light sources, as the pixilation effect is unpleasant to look at and typically provides substantially more glare and less comfort when viewing, in comparison to traditional light sources. The same is true if one considers trying to place a conventional light engine within, for example, a tubular shape similar to conventional fluorescent lamps.

Embodiments of the present invention provide lighting devices including a formable flexible light engine, which may be shaped into a defined shape and then retains that defined shape thereafter. The defined shape, in some embodiments, is chosen to match a corresponding shape of a lighting device into which the formable flexible light engine is placed. The defined shape, in some embodiments, is chosen to maximize optical and thermal efficiencies in lighting devices that would have decreased optical and thermal efficiencies if including a conventional flat, rigid light engine. The formable flexible light engine, in some embodiments, when thermoformed (or otherwise formed), is able to serve as a portion of the external housing of the lighting device, which reduces the amount of material needed in the lighting device and thus reduces cost. Further, in some embodiments, the formed flexible light engine is adapted to connect to a cover for the lighting device, through which light is emitted, that would not be possible with a conventional flat, rigid light engine.

In an embodiment, there is provided a lighting device. The lighting device includes: a cover through which emitted light passes; a housing; an interface between the cover and the housing, which couples the cover and the housing; and a formed flexible light engine comprising a flexible substrate and a plurality of solid state light sources located thereon, wherein the plurality of solid state light sources are configured to emit light through the cover, wherein the formed light engine has a defined shape created during the forming process, wherein the defined shape enables placement of the formed light engine within the lighting device.

In a related embodiment, the lighting device may include an interior and an exterior defined by the cover and the housing, a portion of the interface may extend at least partially into the interior, and the defined shape of the formed flexible light engine may enable placement of the formed light engine in the interior of the lighting device such that the portion of the interface does not block light emitted by the formed flexible light engine from passing through the cover.

In another related embodiment, placement of the formed light engine within the lighting device may result in a minimized pixilation effect when viewing the lighting device. In yet another related embodiment, the housing may have a first shape, and the defined shape of the formed flexible light engine may correspond to the first shape of the housing. In a further related embodiment, a vertical cross section of the first shape may be a curve. In another further related embodiment, the formed flexible light engine may include a width, and the defined shape of the formed flexible light engine may correspond to the first shape of the housing across an entirety of the width.

In still another related embodiment, the housing may have an interior surface and an exterior surface, the interior surface may differ in shape from the exterior surface, and the defined shape of the formed flexible light engine may correspond to the shape of the interior surface of the housing. In yet still another related embodiment, a surface of the formed flexible light engine including the plurality of solid state light sources may have reflective properties, and the surface may act as a secondary optical system of the lighting device. In a further related embodiment, the secondary optical system may be configured to provide particular reflection of light emitted by the plurality of solid state light sources of the formed flexible light engine.

In another embodiment, there is provided a method of manufacturing a lighting device. The method of manufacturing includes: placing a formable flexible light engine comprising a flexible substrate and a plurality of solid state light sources located thereon between a pair of shaping structures, wherein the pair of shaping structures together define a shape; securing the pair of shaping structures so that the formable flexible light engine is held in the defined shape; forming the formable flexible light engine to the defined shape by applying heat to the pair of shaping structures and the formable flexible light engine secured therebetween; removing the formable flexible light engine from the pair of shaping structures, such that the formable flexible light engine retains the defined shape after removal; and attaching a cover to the formed formable flexible light engine to create a lighting device, wherein a shape of the lighting device is defined in part by the defined shape of the formed formable flexible light engine.

In a related embodiment, placing may include placing a formable flexible light engine comprising a flexible substrate and a plurality of solid state light sources located thereon between a pair of shaping structures, wherein the pair of shaping structures together define a shape, and wherein a size of the flexible substrate is chosen so as to result in the defined shape.

In another related embodiment, the method of manufacturing may further include receiving a formable flexible light engine comprising a flexible substrate and a plurality of solid state light sources located thereon and a cover; and placing may include placing the received formable flexible light engine between a pair of shaping structures, wherein the pair of shaping structures together define a shape; and attaching may include attaching the received cover to the formed formable flexible light engine to create a lighting device, wherein a shape of the lighting device is defined in part by the defined shape of the formed formable flexible light engine and in part by a shape of the received cover.

In still another related embodiment, attaching may include attaching the formed formable flexible light engine to a housing, wherein the housing has a shape corresponding to the defined shape of the formed formable flexible light engine; and attaching a cover to the housing including the formed formable flexible light engine to create a lighting device, wherein a shape of the lighting device is defined in part by the shape of the housing that corresponds to the defined shape of the formed formable flexible light engine.

In yet another related embodiment, forming may include forming the formable flexible light engine to the defined shape by deforming the formable flexible light engine secured within the pair of shaping structures.

In another embodiment, there is provided a lighting device. The lighting device includes: a cover through which emitted light passes; an interface; and a formed flexible light engine comprising a flexible substrate having a first side and a second side, and a plurality of solid state light sources located on the first side, wherein the plurality of solid state light sources are configured to emit light through the cover, wherein the formed light engine has a defined shape created during the forming process, and wherein the second side defines, at least in part, an exterior of the lighting device.

In a related embodiment, the interface may couple the cover to the formed flexible light engine.

In a further related embodiment, the interface may be located entirely on the exterior of the lighting device. In a further related embodiment, the interface may be a pair of end caps, each located on an opposite side of the lighting device. In a further related embodiment, each end cap in the pair of end caps may include a groove configured to receive a portion of the cover and a portion of the formed flexible light engine. In a further related embodiment, the groove may include a shape corresponding to the cover and the formed flexible light engine. In another further related embodiment, the groove may include a circular shape. In still another further related embodiment, the groove may include at least two curves. In a further related embodiment, a first end cap in the pair of end caps may have a first groove, the second end cap in the pair of end caps may have a second groove, and a shape of the first groove may differ from a shape of the second groove.

In another further related embodiment, the interface may include an adhesive placed between the cover and the formed flexible light engine. In a further related embodiment, placement of the adhesive may result in the exterior of the lighting device being smooth. In another further related embodiment, the adhesive may be placed between the second side of the formed flexible light engine and an interior surface of the cover, such that the exterior of the lighting device is not smooth. In yet another further related embodiment, the adhesive may be placed between the first side of the formed flexible light engine and an exterior surface of the cover, such that the exterior of the lighting device is not smooth.

In yet another further related embodiment, the interface may include a structure configured to receive an edge of the cover and an edge of the formed flexible light engine. In a further related embodiment, a portion of the structure may extend into an interior of the lighting device.

In still another further related embodiment, the cover may have a first edge and a second edge, the formed flexible light engine may have a first edge and a second edge, the interface may include a first interface between the first edge of the cover and the first edge of the formed flexible light engine and a second interface between the second edge of the cover and the second edge of the formed flexible light engine. In a further related embodiment, the first interface and the second interface may be the same. In another further related embodiment, the first interface and the second interface may be different.

In another related embodiment, the interface may be formed by the cover and the formed flexible light engine. In a further related embodiment, the interface may include a first portion, located on the cover, and a second portion, located on the formed flexible light engine. In another further related embodiment, the second portion may include a shaped protrusion and the first portion may include a receptacle configured to receive the shaped protrusion. In yet another further related embodiment, the first portion may include a shaped protrusion and the second portion may include a receptacle configured to receive the shaped protrusion.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIGS. 1A and 1B each show a vertical cross-section of a lighting device including a formed flexible light engine according to embodiments disclosed herein.

FIGS. 2A-2B show, respectively, a partial top perspective view and an interior perspective view of a lighting device including a traditional light engine.

FIGS. 2C-2D show, respectively, a partial top perspective view and an interior perspective view of a lighting device including a formed flexible light engine according to embodiments disclosed herein.

FIG. 3 shows a housing having a shape and a formed flexible light engine having a corresponding shape, according to embodiments disclosed herein.

FIG. 4 shows an interior perspective view of a lighting device including a formed flexible light engine corresponding to an interior surface of a housing according to embodiments disclosed herein.

FIGS. 5A-5E show a method of manufacturing a lighting device according to embodiments disclosed herein.

FIGS. 6A-6B show, respectively, a perspective view and a vertical cross-section of a lighting device including an interface, according to embodiments disclosed herein.

FIGS. 7A-7B show, respectively, a perspective view and a vertical cross-section of a lighting device including an interface, according to embodiments disclosed herein.

FIG. 8 shows a lighting device having, as shown in cutout, one or more end caps, according to embodiments disclosed herein.

FIG. 9A shows a portion of a lighting device having a formable cover and a corresponding end cap, according to embodiments disclosed herein.

FIG. 9B illustrates another end cap, according to embodiments disclosed herein.

FIGS. 10A and 10B each show a lighting device including an adhesive, according to embodiments disclosed herein.

FIG. 11 shows a lighting device formed from a combination of the cover and formed flexible light engine, which together create the interface, according to embodiments disclosed herein.

FIG. 12 is a perspective view of a lighting device including two different types of interfaces, according to embodiments disclosed herein.

### DETAILED DESCRIPTION

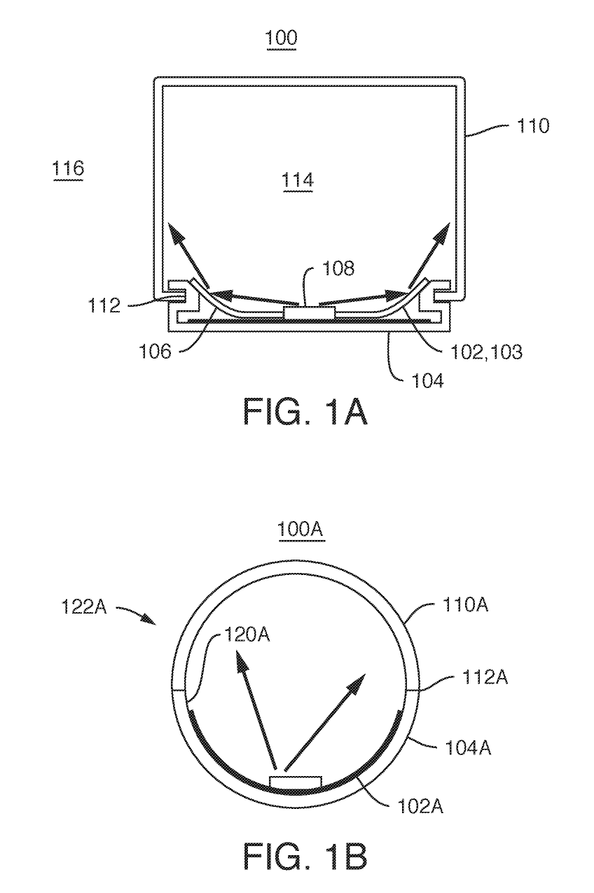

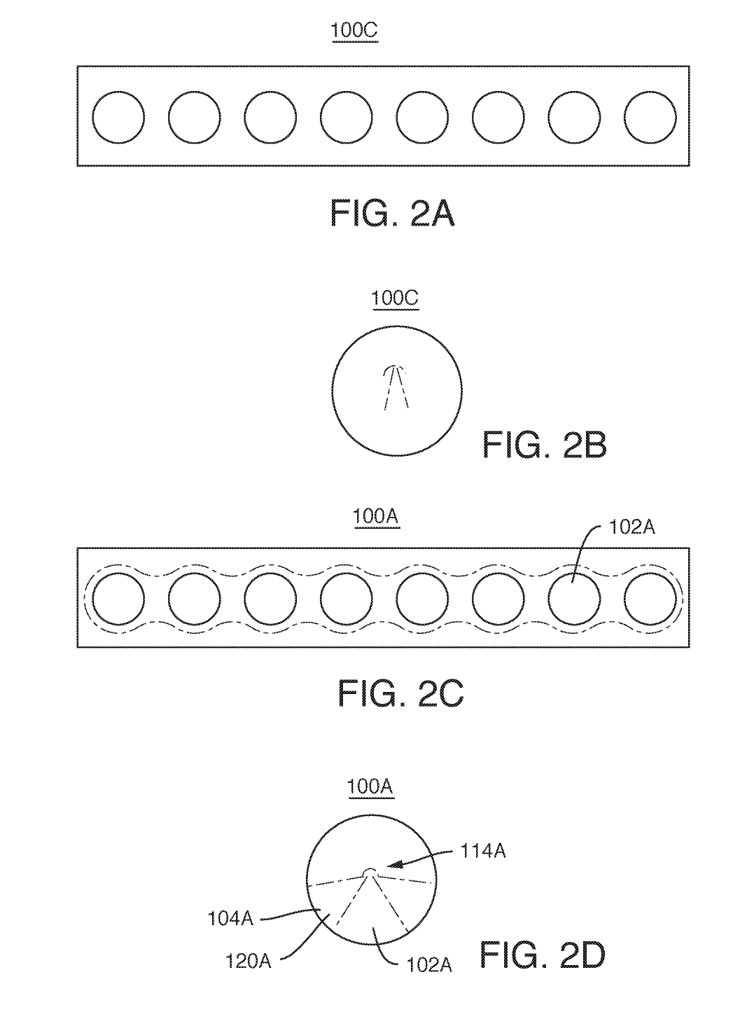

FIG. 1A shows a cross-section of a lighting device 100 including a formed flexible light engine 102, placed on a housing 104. The formed flexible light engine 102 comprises a flexible (or substantially flexible) substrate 106, such as but not limited to PET, and a plurality of solid state light sources 108 located thereon. Though the cross-section view shown in FIG. 1A shows only a single solid state light source 108, the plurality of solid state light sources is shown in FIG. 2D, among others. The formed flexible light engine 102 has a defined shape 103, of which a cross-section is seen in FIG. 1A. The defined shape 103 of the formed flexible light engine 102 is created during the forming process, as described in greater detail below. The plurality of solid state light sources 108 are configured to emit light through a cover 110 of the lighting device 100. The lighting device 100 also includes an interface 112 between the housing 104 and the cover 110. The interface 112 couples the housing 104 and the cover 110 together. As seen in FIG. 1A, the lighting device 100 includes an interior 114 and an exterior 116. The formed flexible light engine 102 is located on the interior 114 of the lighting device 100, and it is the defined shape 103 of formed flexible light engine 102 that allows this placement. More specifically, as seen in FIG. 1A, a portion of the interface 112 extends at least partially into the interior 114 of the lighting device 100. If the lighting device 100 included a traditional (substantially) flat, (substantially) rigid light engine, the portion of the interface 112 that extends at least partially into the interior 114 of the lighting device 100 would block some of the light emitted by the traditional light engine from exiting the lighting device 100. The defined shape 103 of the formed flexible light engine 102, in contrast, allows placement of the formed flexible light engine 102 within the interior 114 of the lighting device 100 such that the portion of the interface 112 that extends at least partially into the interior 114 does not block light emitted by the formed flexible light engine 102 from passing through the cover 110.

FIG. 1B shows a cross-section view of a lighting device 100A similar in components to the lighting device 100 of FIG. 1A, but with a different shape. Thus, the shown cross-section of the lighting device 100A, which is a vertical cross-section, has a circular shape, with a cover 110A being a curve and a housing 104A also being a curve. The cover 110A and the housing 104A thus each have a curved shape, and the overall shape of the lighting device 100A is tubular. As seen in FIG. 1B, the lighting device 100A includes a formed flexible light engine 102A, similar in composition to the formed flexible light engine 102 of FIG. 1A but having a different defined shape. In FIG. 1B, the formed flexible light engine 102A has a defined shaped that is also, in vertical cross-section, a curve, and thus overall is a curved shape. The curved shape of the formed flexible light engine 102A corresponds to the curved shape of the housing 104A. That is, the formed flexible light engine 102A follows the shape of an interior surface 120A of the housing 104A. Though FIG. 1B shows curved shapes, of course, other shapes are also possible for the housing, the cover, and the formed flexible light engine, such as rectangular shapes as shown in FIG. 1A, as well as triangular shapes, quadrilateral shapes, and other polygonal shapes.

The lighting device 100A shown in FIG. 1B thus demonstrates how a formed flexible light engine, as described throughout, is able to be placed in a lighting device in such a way that complements and/or follows the shape of the lighting device. FIG. 2C shows a portion of the lighting device 100A of FIG. 1B from a top perspective, with a portion of the plurality of solid state light sources of the formed flexible light engine 102A emitting light. In contrast, FIG. 2A shows a portion of a similarly shaped lighting device 100C from the same perspective. The lighting device 100C of FIG. 2A instead includes a traditional rigid, flat light engine, which is placed across an interior of the lighting device 100C, with a portion of its solid state light sources emitting light. As seen in FIG. 2A, there is a clear pixilation effect, where the light emitted by each solid state light source shown is clearly distinct from the light emitted by each other solid state light source shown. The lighting device 100A of FIG. 2C, in contrast, shows a minimized pixilation effect, due to the placement of the formed flexible light engine 102A within the lighting device 100A. The placement of the light engine within the respective lighting devices is seen more clearly in FIGS. 2B and 2D. FIG. 2B shows a perspective view of the interior of the lighting device 100C of FIG. 2A, with the traditional light engine located approximately in the center of the lighting device 100C. FIG. 2D shows a perspective view of an interior 114A of the lighting device 100A, with the formed flexible light engine 102A placed along the interior surface 120A of the housing 104A. The increase in distance between the respective light engines and covers of the lighting devices 100C and 100A assists in the minimization of the pixilation effect. This increase in distance is achieved when the formable flexible light engine has been formed to have, for example but not limited to, the same arc of curvature as the housing of the lighting device. Optical efficiency is improved, due to minimized diffusion, and more direct contact between the formed flexible light engine and the housing of the lighting device results in improved thermal efficiency as well.

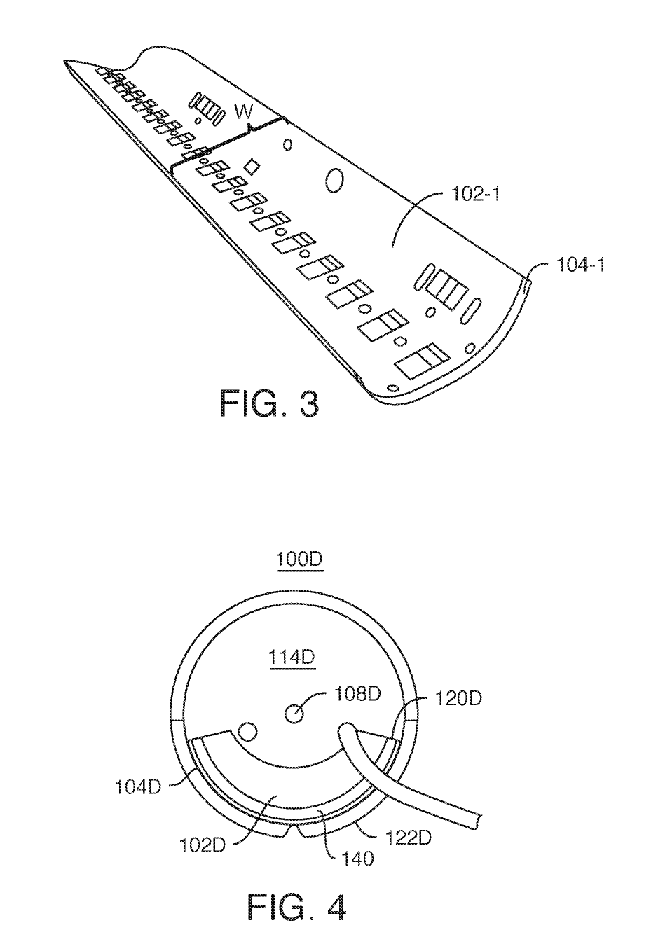

FIG. 3 shows a housing 104-1 and a formed flexible light engine 102-1 placed thereon. The housing 104-1 and the formed flexible light engine 102-1 each have a defined shape, and the defined shape of the formed flexible light engine 102-1 corresponds to the shape of the housing 104-1, similarly to the housing 104A and the formed flexible light engine 102A of FIG. 1B. In FIG. 3, the formed flexible light engine 102-1 has a width W, and the defined shape of the formed flexible light engine 102-1 corresponds to the shape of the housing 104-1 across the entire width W. In some embodiments, such as shown in FIG. 1A, for example, the defined shape of the formed flexible light engine 102 does not correspond to the shape of the housing 104 across an entire width of the formed flexible light engine 102. In some embodiments, such as shown in FIG. 4, a lighting device 100D includes a housing 104D that has an interior surface 120D and an exterior surface 122D. The interior surface 120D and the exterior surface 122D each include a curved shape. However, the interior surface 120D differs from the exterior surface 122D in that the interior surface 120D shown in FIG. 4 extends laterally inward towards an interior 114D of the lighting device 100D and then returns to following a curve similar to that of the exterior surface 122D, on each side of the housing 104D. The exterior surface 122D does not include the lateral extensions. A formed flexible light engine 102D of the lighting device 100D corresponds to the shape of the interior surface 120D, as shown.

Some embodiments of a formed flexible light engine, such as the formed flexible light engine 102D shown in FIG. 4, include a surface 140. The surface 140 is that surface of the formed flexible light engine 102D that includes a plurality of solid state light sources 108D. The surface 140 shown in FIG. 4 has reflective properties, either inherent in the materials used in creating the formed flexible light engine 102D or added during or after its creation, such as but not limited to via coating, painting, and the like. The reflective properties of the surface 140 increase the optical efficiency, and overall light output, of the lighting device 100D. The reflective properties of the surface 140 also assist in minimizing the pixilation effect. Thus, the reflective properties of the surface 140 act as a secondary optical system for the lighting device 100D. The defined shape of the formed flexible light engine impacts the effect of its reflective properties. For example, the defined shape of the formed flexible light engine 102 of FIG. 1A will produce different secondary optical effects than the defined shape of the formed flexible light engine 102A of FIG. 1B, which is a different shape. A formed flexible light engine according to embodiments disclosed herein thus may be, and in some embodiments is, shaped to increase the secondary optical effects of the formed flexible light engine 102, to conform to a shape of the housing for the associated lighting device, and combinations thereof, without departing from the scope of the invention.

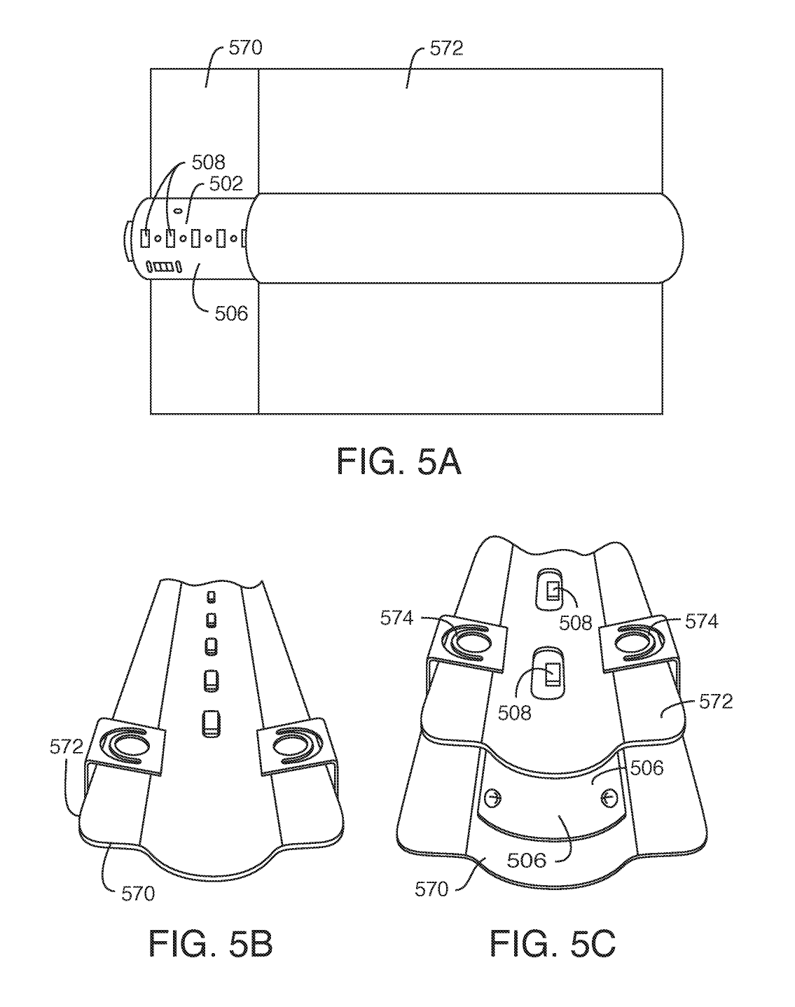

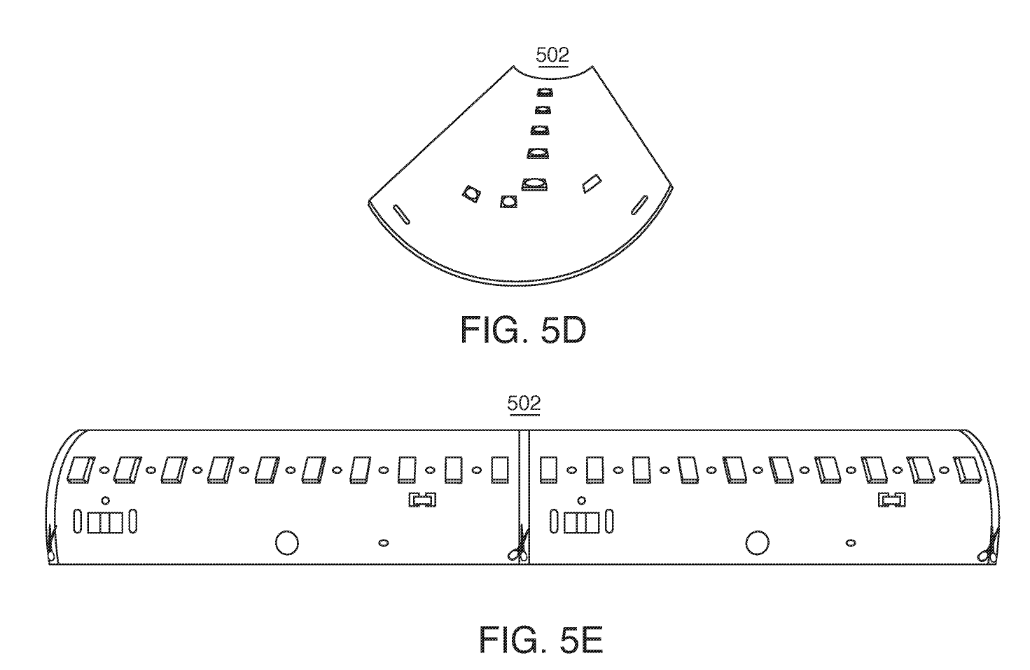

FIGS. 5A-5E show a method of manufacturing a lighting device, such as but not limited to any of the lighting devices shown throughout. In FIGS. 5A and 5C, a formable flexible light engine 502, comprising a flexible substrate 506 and a plurality of solid state light sources 508 located thereon, is placed between a pair of shaping structures 570, 572. Together, the pair of shaping structures 570, 572 define a shape. In FIG. 5A, that shape is a convex curve, and in FIG. 5C, it is a concave curve, though such shapes are shown only for ease of explanation, and of course any other known shape may be defined by the pair of shaping structures 570, 572. In some embodiments, a size of the flexible substrate 506 is chosen so as to result in the defined shape. That is, for example, in some embodiments, extra material is used in creating the formable flexible light engine 502 such that the extra material permits forming the formable flexible light engine 502 into a particular shape that would not be possible without the extra material. The extra material is added to any portion of the formable flexible light engine 502 to achieve the desired shape.

As shown in FIGS. 5B and 5C, the pair of shaping structures 570, 572 are secured, so as to hold the formable flexible light engine 502 placed therebetween in the defined shape. The pair of shaping structures 570, 572 may be, and in some embodiments are, secured in any known fashion, such as but not limited to using clips 574 (shown in FIG. 5C), screws, reusable adhesive, pins, brackets, and the like. Any known securing feature is possible, so long as the formed flexible light engine is able to removed after undergoing the forming process.

The formable flexible light engine 502 is then formed to the defined shape. In some embodiments, this is done by applying heat to the pair of shaping structures 570, 572 and the formable flexible light engine 502 secured therebetween. In some embodiments, the pair of shaping structures 570, 572 and the formable flexible light engine 502 secured therebetween are placed into an oven having a temperature of substantially 110° C. for 20-30 minutes, though of course any known heat source and/or any known temperature and/or any known time suitable to thermoform the formable flexible light engine may be, and in some embodiments are, used. In some embodiments, forming is done by deforming the formable flexible light engine 502 secured within the pair of shaping structures 570, 572. In some embodiments, other types of forming are used. Following forming, the formable flexible light engine 502 is removed from the pair of shaping structures 570, 572, such that the formable flexible light engine 502 retains the defined shape after removal. This is shown in FIGS. 5D and 5E, which show, respectively, the formable flexible light engine 502 shown in FIGS. 5B-5C and 5A, after being formed. Thus, the formed flexible light engine 502 shown in FIG. 5D has a hemicylindrical concave shape, and retains that hemicylindrical concave shape after being removed from the pair of shaping structures 570, 572 shown in FIGS. 5B and 5C. Similarly, the formed flexible light engine 502 shown in FIG. 5E has a hemicylindrical convex shape, and retains that hemicylindrical convex shape after being removed from the pair of shaping structures 570, 572 shown in FIG. 5A. The forming process, though it alters the shape of the formable flexible light engine, does not otherwise harm or disrupt its operation.

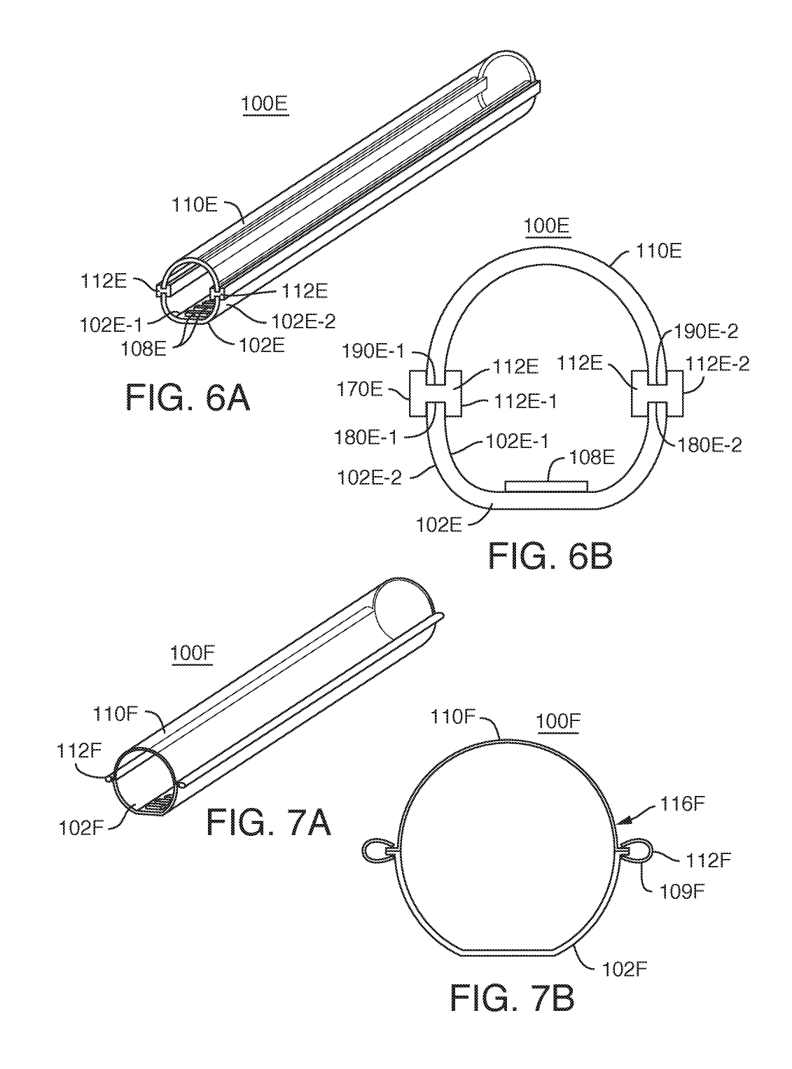

A cover (not shown in FIGS. 5A-5E but shown in, for example, FIG. 6) is then attached to the formed formable flexible light engine 502 to create a lighting device (not shown in FIGS. 5A-5E, but shown in, for example, FIG. 6). The shape of the lighting device, in some embodiments, is defined in part by the defined shape of the formed formable flexible light engine 502. In some embodiments, the shape of the lighting device is defined in part by the defined shape of the formed formable flexible light engine 502 and in part by a shape of the attached cover.

Alternatively, in some embodiments (such as shown in FIG. 1B), the formed formable flexible light engine 502 is attached to a housing, which has a shape corresponding to the defined shape of the formed formable flexible light engine 502. A cover is then attached to the housing to create the lighting device. A shape of the lighting device is defined in part by the shape of the housing that corresponds to the defined shape of the formed formable flexible light engine 502.

In embodiments where the formed flexible light engine is used as the housing for the lighting device, manufacturing of the lighting device is further simplified, by eliminating a component and its related cost. A formed flexible light engine, such as shown in FIG. 5D, has the necessary rigidity and thermal dissipation properties to serve as the housing for a lighting device. When combined with a cover through which light emitted from the formed flexible light engine passes, as described throughout, it is possible to create a lighting device having a particular shape. To join the cover and the formed flexible lighting device requires, in some embodiments, an interface. Such an embodiment is shown in, for example, FIGS. 6A and 6B. In FIG. 6A, which is a perspective view of a lighting device 100E, a formed flexible light engine 102E is coupled to a cover 110E by an interface 112E. The formed flexible light engine 102E includes a first side 102E-1 and a second side 102E-2. A plurality of solid state light sources 108E, located on the first side 102E-1, are configured to emit light through the cover 110E. The formed flexible light engine 102E has a defined shape created during the forming process, and the second side 102E-2 defines, at least in part, an exterior of the lighting device 100E. Thus, as seen in FIG. 6A but also seen in FIG. 6B, which is a vertical cross-section of the lighting device 100E, the hemicylindrical shaped cover 110E is joined with the shaped formed flexible light engine 102E, having a shaped portion joining two curved portions, to give an overall shape to the lighting device 100E. In FIGS. 6A-6B, the interface 112E includes a structure 170E configured to receive an edge 190E-1 of the cover 110E and an edge 180E-1 of the formed flexible light engine 102E. In some embodiments, such as shown in FIGS. 6A and 6B, a portion of the structure 170E extends into an interior 114E of the lighting device 100E. In some embodiments, such as shown in FIGS. 7A and 7B, the structure that forms the interface does not extend into the interior of the lighting device. In some embodiments, the cover 110E has a first edge 190E-1 and a second edge 190E-2, and similarly, the formed flexible light engine 102E has a first edge 180E-1 and a second edge 180E-2. In such embodiments, the interface 112E includes a first interface 112E-1 and a second interface 112E-2. The first interface 112E-1 is between the first edge 190E-1 of the cover 110E and the first edge 180E-1 of the formed flexible light engine 102E. The second interface 112E-2 is between the second edge 190E-2 of the cover 110E and the second edge 180E-2 of the formed flexible light engine 102E. In some embodiments, as shown in FIGS. 6A and 6B, the first interface 112E-1 and the second interface 112E-2 are the same. In some embodiments, the first interface 112E-1 and the second interface 112E-2 are different, as shown in FIG. 12.

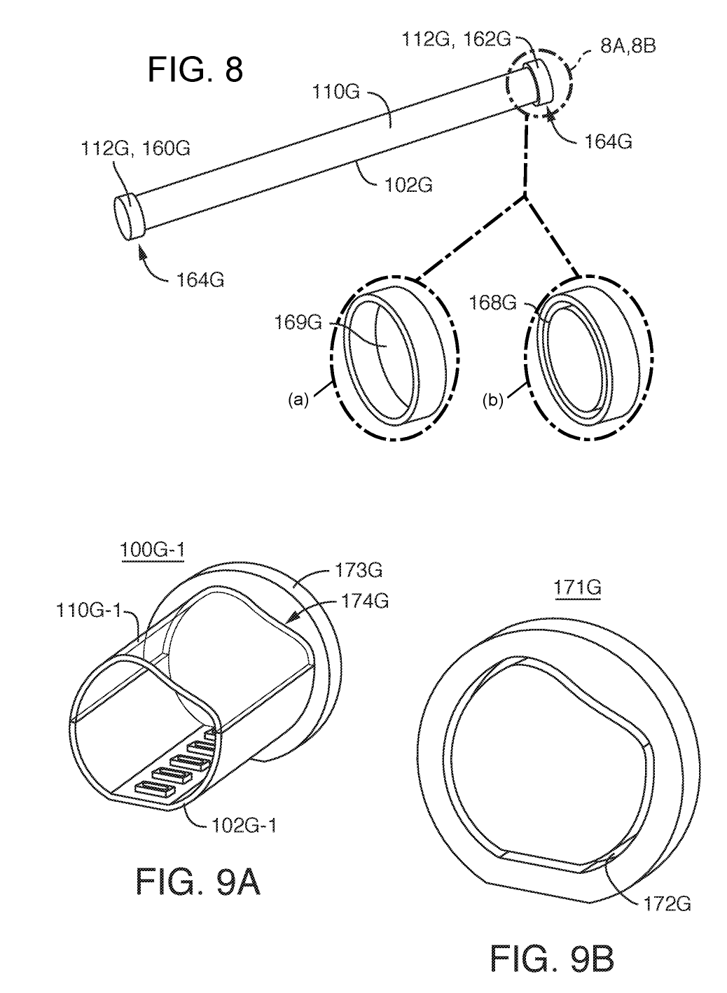

In some embodiments, such as briefly described above, the interface is not located on an interior of the lighting device, but rather is located entirely on the exterior of the lighting device. This is done in a variety of ways. For example, as shown in the perspective view of FIG. 7A, a lighting device 100F includes a formed flexible light engine 102F and a cover 110F, with an interface 112F that couples these together. As seen more clearly in the vertical cross-section with cut-out shown in FIG. 7B, the interface 112F is formed by bending a portion of both of the cover 110F and the formed flexible light engine 102F, on each of their respective edges, outward such that these bent edges contact each other. A joining mechanism 109F couples the bent edges together. The bent edges and the joining mechanism 109F (and thus the interface 112F) are located entirely on an exterior 116F of the lighting device 100F. Additionally, or in some embodiments, alternatively, such as seen in FIGS. 8, 9A, and 9B, the interface is a pair of end caps, each located on an opposite side of the lighting device. Thus, FIG. 8 shows a lighting device 100G, similar to the lighting devices described above, except that an interface 112G is a pair of end caps 160G, 162G, located on opposite sides 164G, 166G of the lighting device 100G. In some embodiments, as shown in the cutout labeled “(b)”, each end cap in the pair of end caps 160G, 162G includes a groove 168G configured to receive a portion of a cover 110G and a portion of the formed flexible light engine 102G, as the combination of these two elements forms an exterior shape of the lighting device 100G. In some embodiments, as shown in the cutout labeled “(a)” in FIG. 8, the groove 168G is a shape corresponding to the cover 110G and the formed flexible light engine 102G, such as but not limited to a circle 169G, which receives the circular ends of the cover 110G and the formed flexible light engine 102G. In some embodiments, the groove 168G includes two curves. Another example of such an embodiment is shown in FIG. 9B. In FIG. 9B, an end cap 171G is shaped so as to include a groove 172G having two curves, joined by a lateral connection and a sloped connection, respectively. Such embodiments show the ability for a cover of a lighting device according to embodiments disclosed herein to have unconventional shapes. FIG. 9A shows a portion of such a lighting device 100G-1. In FIG. 9A, the lighting device 100G-1 includes an end cap 173G with a groove 174G, similar to the shape of the groove 172G shown in FIG. 9B. An end cap (not shown in FIG. 9A) similar to the end cap 160G shown in the cutout labeled “(a)” of FIG. 8, having a groove similar to the circular opening groove 168G of the end cap 160G, is placed on the other side of the lighting device 100G-1 (not shown in FIG. 9A). The groove of this end cap differs from the groove 174G of the end cap 173G, yet each end cap still fits on the lighting device 100G-1.

In some embodiments, such as shown in FIGS. 9A and 9B, a cover 110G-1 is itself formable, such that non-traditional shapes for both a formed flexible light engine 102G-1 and the cover 110G-1, and combinations resulting therefrom, are possible. In some embodiments where a formable cover 110G-1 is used, one or more of the end caps provide at least part of the shaping of the cover 110G-1, and thus the lighting device 100G-1, by (for example) holding the formable cover 110G-1 in a particular shape. In some embodiments, also shown in FIGS. 9A and 9B, one or more of the end caps for the lighting device 100G-1 are themselves formable, and thus may be shaped in any way to accommodate the lighting device 100G-1.

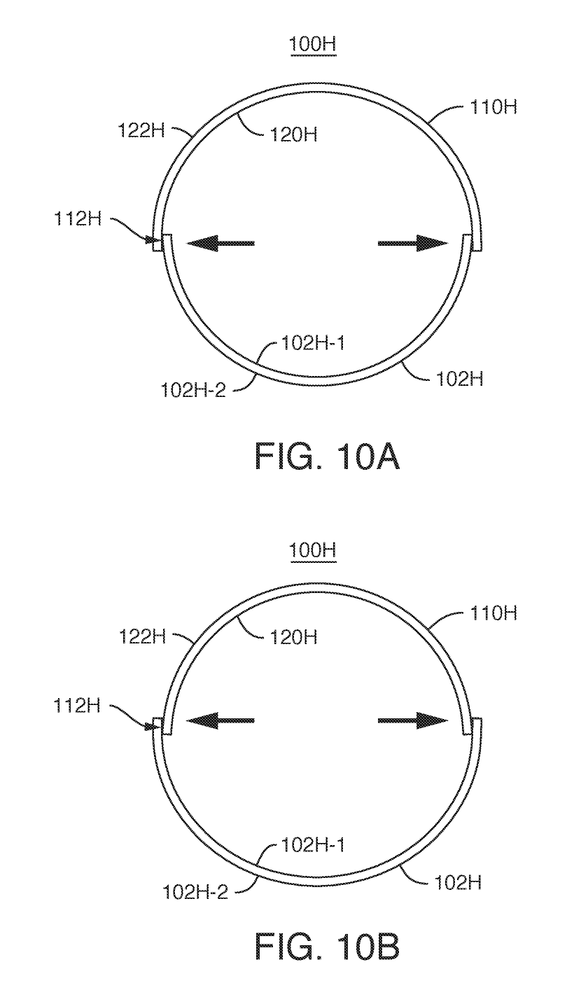

FIGS. 10A and 10B show respective vertical cross-sections of lighting devices including an adhesive as the interface. In FIGS. 10A and 10B, a lighting device 100H includes as an interface an adhesive 112H. The adhesive 112H is placed between a cover 110H and a formed flexible light engine 102H. The cover 110H includes an interior surface 120H and an exterior surface 122H. The formed flexible light engine 102H includes a first side 102H-1, primarily facing the interior surface 120H of the cover 110H, and a second side 102H-2. In some embodiments, as shown in FIG. 10A, the adhesive 112H is placed between the second side 102H-2 of the formed flexible light engine 102H and the interior surface 120H of the cover 110H, resulting in a non-smooth exterior for the lighting device 100H. Alternatively, in some embodiments, as shown in FIG. 10B, the adhesive 112H is placed between the first side 102H-1 of the formed flexible light engine 102H and the exterior surface 122H of the cover 110H, also resulting in a non-smooth exterior of the lighting device 100H. In contrast, in some embodiments, such as shown in FIG. 1B, placement of an adhesive 112A results in the exterior 122A of the lighting device 100A being smooth. The adhesive 112H may be, and in some embodiments is, but is not limited to, glue, tape, epoxy, and the like, or through welding techniques (such as but not limited to hot melting, laser welding ultrasonic welding, etc.).

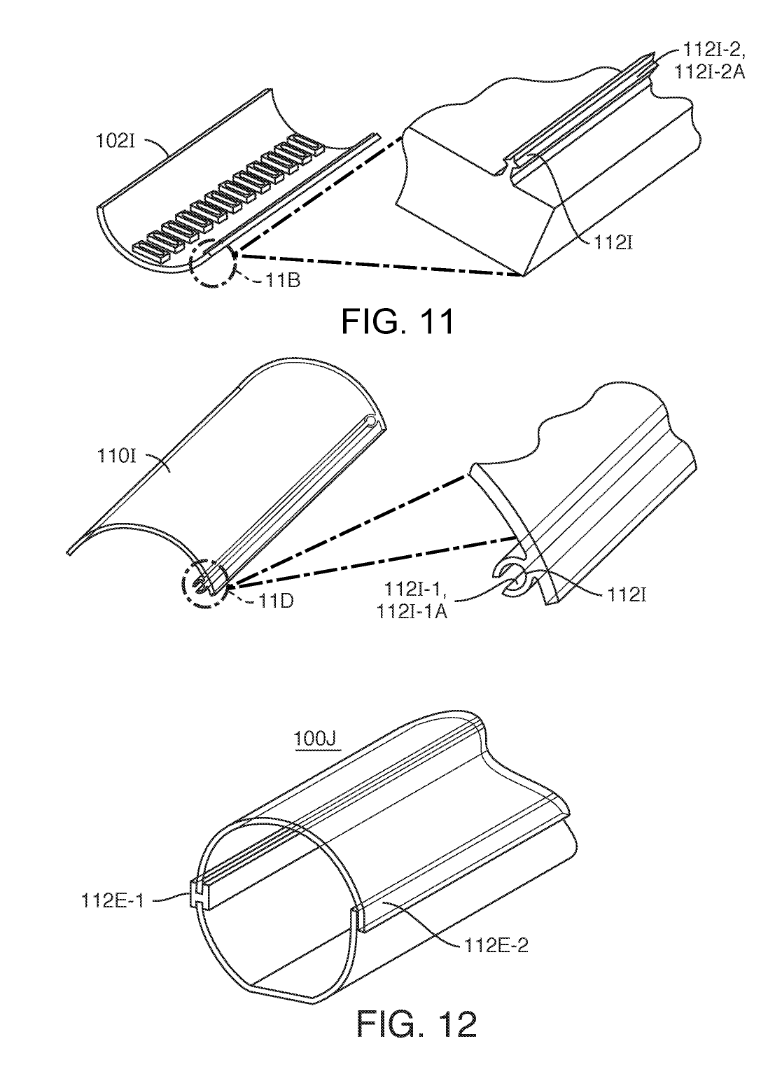

FIG. 11 shows a portion of a formed flexible light engine 102I and a cover 110I, each with a respective cutout to show finer detail. Here, an interface 112I is formed by the cover 110I and the formed flexible light engine 102I. The interface 112I includes a first portion 112I-1, located on the cover 110I, and a second portion 112I-2, located on the formed flexible light engine 102I. In some embodiments, as shown in FIG. 11, the second portion 112I-2 comprises a shaped protrusion 112I-2A and the first portion 112I-1 comprises a receptacle 112I-1A configured to receive the shaped protrusion 112I-2A. In some embodiments, this arrangement is flipped, such that the first portion 112I-1 comprises the shaped protrusion 112I-2A and the second portion 112I-2 comprises the receptacle 112I-2B.

In some embodiments, such as shown in FIG. 11, one of the formed flexible light engine and the optical cover includes a protuberance and the other including a mating receptacle. When the protuberance and the mating receptacle are connected, the formed flexible light engine and the optical cover are joined into a lighting device.

Though various interfaces are described throughout, of course it is possible to use combinations of these to join a cover to a formed flexible light engine, or to a housing including a formed flexible light engine. An example of such a combination is shown in a lighting device 100J of FIG. 12. In some embodiments, it is possible to use combinations to join multiple optical covers to one or more corresponding formed flexible light engines and/or housings including the same.

Embodiments thus provide for both varied and flexible manufacturing processes to create lighting devices using formable flexible light engines. For example, some customers may form the formable flexible light engine into a particular shape after they receive the same, allowing the formable flexible light engine to be easily transported to the customer. In some embodiments, the optical cover may be removed from the rest of the lighting device and changed for a different optical cover. In some embodiments, the customer may both form the formable flexible light engine into a particular shape and connect an optical cover of their own manufacture or supply thereto, simplifying logistics and decreasing manufacturing cost.

In some embodiments, the formed flexible light engine has a flexible substrate that is made of a polymer, such as but not limited to polyethylene terephthalate (PET), polyethylene (PE), polyimide (PI), and the like. In some embodiments, the thickness of the flexible substrate is within a range, such as but not limited to 0.1-0.5 mm, 0.1-1.0 mm, 0.01-10 mm, and so forth. The optical cover used in some embodiments is light-transmissive and includes any optical feature or features (e.g., clear, translucent, diffusive, micro-optics, etc., including combinations thereof). In some embodiments, the optical cover is made of a polymeric material, such as but not limited to polycarbonate (PC), polymethyl methacrylate (PMMA), polyethylene terephthalate (PET), polyethylene (PE), polyimide (PI), and the like, and the thickness in some embodiments is in the range of 0.1-0.2 mm, 0.1-1.0 mm, 0.01-10 mm, and so forth.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A lighting device, comprising:
a cover through which emitted light passes;
a housing;
an interface between the cover and the housing, which couples the cover and the housing; and
a formed flexible light engine comprising a flexible substrate and a plurality of solid state light sources located thereon, wherein the plurality of solid state light sources are configured to emit light through the cover, wherein the formed light engine has a defined shape created during the forming process, wherein the defined shape enables placement of the formed light engine within the lighting device.

2. The lighting device of claim 1, wherein the lighting device has an interior and an exterior defined by the cover and the housing, wherein a portion of the interface extends at least partially into the interior, and wherein the defined shape of the formed flexible light engine enables placement of the formed light engine in the interior of the lighting device such that the portion of the interface does not block light emitted by the formed flexible light engine from passing through the cover.

3. The lighting device of claim 1, wherein placement of the formed light engine within the lighting device results in a minimized pixilation effect when viewing the lighting device.

4. The lighting device of claim 1, wherein the housing has a first shape, and wherein the defined shape of the formed flexible light engine corresponds to the first shape of the housing.

5. The lighting device of claim 4, wherein a vertical cross section of the first shape is a curve.

6. The lighting device of claim 4, wherein the formed flexible light engine comprises a width, and wherein the defined shape of the formed flexible light engine corresponds to the first shape of the housing across an entirety of the width.

7. The lighting device of claim 1, wherein the housing has an interior surface and an exterior surface, wherein the interior surface differs in shape from the exterior surface, and wherein the defined shape of the formed flexible light engine corresponds to the shape of the interior surface of the housing.

8. The lighting device of claim 1, wherein a surface of the formed flexible light engine including the plurality of solid state light sources has reflective properties, and wherein the surface acts as a secondary optical system of the lighting device.

9. The lighting device of claim 8, wherein the secondary optical system is configured to provide particular reflection of light emitted by the plurality of solid state light sources of the formed flexible light engine.

10. A method of manufacturing a lighting device, comprising:
placing a formable flexible light engine comprising a flexible substrate and a plurality of solid state light sources located thereon between a pair of shaping structures, wherein the pair of shaping structures together define a shape;
securing the pair of shaping structures so that the formable flexible light engine is held in the defined shape;
forming the formable flexible light engine to the defined shape by applying heat to the pair of shaping structures and the formable flexible light engine secured therebetween;
removing the formable flexible light engine from the pair of shaping structures, such that the formable flexible light engine retains the defined shape after removal; and
attaching a cover to the formed formable flexible light engine to create a lighting device, wherein a shape of the lighting device is defined in part by the defined shape of the formed formable flexible light engine.

11. The method of manufacturing of claim 10, wherein placing comprises:
placing a formable flexible light engine comprising a flexible substrate and a plurality of solid state light sources located thereon between a pair of shaping structures, wherein the pair of shaping structures together define a shape, and wherein a size of the flexible substrate is chosen so as to result in the defined shape.

12. The method of manufacturing of claim 10, further comprising:
receiving a formable flexible light engine comprising a flexible substrate and a plurality of solid state light sources located thereon and a cover;
and wherein placing comprises:
placing the received formable flexible light engine between a pair of shaping structures, wherein the pair of shaping structures together define a shape;
and wherein attaching comprises:
attaching the received cover to the formed formable flexible light engine to create a lighting device, wherein a shape of the lighting device is defined in part by the defined shape of the formed formable flexible light engine and in part by a shape of the received cover.

13. The method of manufacturing of claim 10, wherein attaching comprises:
attaching the formed formable flexible light engine to a housing, wherein the housing has a shape corresponding to the defined shape of the formed formable flexible light engine; and
attaching a cover to the housing including the formed formable flexible light engine to create a lighting device, wherein a shape of the lighting device is defined in part by the shape of the housing that corresponds to the defined shape of the formed formable flexible light engine.

14. The method of manufacturing of claim 10, wherein forming comprises:
forming the formable flexible light engine to the defined shape by deforming the formable flexible light engine secured within the pair of shaping structures.

15. A lighting device, comprising:
a cover through which emitted light passes;
an interface; and
a formed flexible light engine comprising a flexible substrate having a first side and a second side, and a plurality of solid state light sources located on the first side, wherein the plurality of solid state light sources are configured to emit light through the cover, wherein the formed light engine has a defined shape created during the forming process, and wherein the second side defines, at least in part, an exterior of the lighting device.

16. The lighting device of claim 15, wherein the interface couples the cover to the formed flexible light engine.

17. The lighting device of claim 16, wherein the interface is located entirely on the exterior of the lighting device.

18. The lighting device of claim 17, wherein the interface is a pair of end caps, each located on an opposite side of the lighting device.

19. The lighting device of claim 18, wherein each end cap in the pair of end caps includes a groove configured to receive a portion of the cover and a portion of the formed flexible light engine.

20. The lighting device of claim 19, wherein the groove comprises a shape corresponding to the cover and the formed flexible light engine.

21. The lighting device of claim 19, wherein the groove comprises a circular shape.

22. The lighting device of claim 19, wherein the groove includes at least two curves.

23. The lighting device of claim 19, wherein a first end cap in the pair of end caps has a first groove, wherein the second end cap in the pair of end caps has a second groove, and wherein a shape of the first groove differs from a shape of the second groove.

24. The lighting device of claim 16, wherein the interface comprises an adhesive placed between the cover and the formed flexible light engine.

25. The lighting device of claim 24, wherein placement of the adhesive results in the exterior of the lighting device being smooth.

26. The lighting device of claim 24, wherein the adhesive is placed between the second side of the formed flexible light engine and an interior surface of the cover, such that the exterior of the lighting device is not smooth.

27. The lighting device of claim 24, wherein the adhesive is placed between the first side of the formed flexible light engine and an exterior surface of the cover, such that the exterior of the lighting device is not smooth.

28. The lighting device of claim 16, wherein the interface comprises a structure configured to receive an edge of the cover and an edge of the formed flexible light engine.

29. The lighting device of claim 28, wherein a portion of the structure extends into an interior of the lighting device.

30. The lighting device of claim 16, wherein the cover has a first edge and a second edge, wherein the formed flexible light engine has a first edge and a second edge, wherein the interface comprises a first interface between the first edge of the cover and the first edge of the formed flexible light engine and a second interface between the second edge of the cover and the second edge of the formed flexible light engine.

31. The lighting device of claim 30, wherein the first interface and the second interface are the same.

32. The lighting device of claim 30, wherein the first interface and the second interface are different.

33. The lighting device of claim 15, wherein the interface is formed by the cover and the formed flexible light engine.

34. The lighting device of claim 33, wherein the interface comprises a first portion, located on the cover, and a second portion, located on the formed flexible light engine.

35. The lighting device of claim 34, wherein the second portion comprises a shaped protrusion and the first portion comprises a receptacle configured to receive the shaped protrusion.

36. The lighting device of claim 34, wherein the first portion comprises a shaped protrusion and the second portion comprises a receptacle configured to receive the shaped protrusion.
